(19) United States
(12) Patent Application Publication
(10) Pub. No.: US 2008/0071623 A1
(43) Pub. Date: Mar. 20, 2008

(54) ADMINISTRATING SYSTEM AND METHOD FOR MATERIAL PURCHASING

(76) Inventors: KUNG-CHIEH CHENG, Tu-Cheng (TW); Ming-Fu Wu, Shenzhen (CN); Fu-Qiang He, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(21) Appl. No.: 11/615,916

(22) Filed: Dec. 22, 2006

(30) Foreign Application Priority Data
Aug. 25, 2006 (CN) 200610200820.0

(51) Int. Cl. G06Q 30/00

(52) U.S. Cl. 705/15

(57) ABSTRACT

An administrating system for material purchasing includes a request input module, a request messaging module, and an approval processing module. The request input module is used for receiving a purchasing request message from a request terminal. The request messaging module is used for forwarding the purchasing request message to an approval terminal. The approval processing module is used for receiving a request reply message to the purchasing request message from the approval terminal. An administrating method for material purchasing is also disclosed.

### BACKGROUND OF THE INVENTION

1. Field of the Invention

The present invention generally relates to administrating systems and methods, and more particularly to an administrating system and method for material purchasing.

2. Description of Related Art

Companies and factories need to purchase materials from suppliers for their operations.

Generally, clerks of the companies and factories (hereinafter called purchasers) gather product supply information from information sources such as newspapers, magazines, and websites, and prepare paper documents for being approved by those persons in charge, such as managers. The approved documents are then transferred to purchasing departments. The purchasing departments accordingly send purchase orders to corresponding suppliers.

Too much human participation was taken in the above process, and a lot of time is needed to prepare the documents, to request the documents for approval, and to deliver the approved documents. The purchasing departments have to spend a lot of time on checking whether the documents have been approved by the persons in charge. Particularly, when there are a lot of request documents needed to be approved by the person in charge, he or she would often be disturbed. They all suffer greatly from low efficiency of this procedure.

Therefore, an administrating system and method for material purchasing is needed in the industry to effectively administration material purchasing.

### SUMMARY OF THE INVENTION

An administrating system for material purchasing includes a request input module, a request messaging module and an approval processing module. The request input module is used for receiving a purchasing request message from a request terminal. The request messaging module is used for forwarding the purchasing request message to an approval terminal. The approval processing module is used for receiving a request reply message to the purchasing request message from the approval terminal.

An administrating method for material purchasing, includes the steps of: receiving a purchasing request message; forwarding the purchasing request message to be approved; and generating a purchasing order.

Other systems, methods, features, and advantages of the present administrating system and method will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present administrating system and method can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a block diagram of a system environment incorporating an exemplary embodiment of an administrating system;

FIG. 2 is a more detailed block diagram of the administrating system in accordance with an exemplary embodiment;

FIG. 3 is a flow chart of an administrating method in accordance with an exemplary embodiment; and

FIG. 4 is a more detailed flow chart illustrating an exemplary embodiment of the administrating method.

### DETAILED DESCRIPTION OF THE INVENTION

Reference will now be made to the drawings to describe a preferred embodiment of the present administrating system and preferred embodiments of the present administrating method.

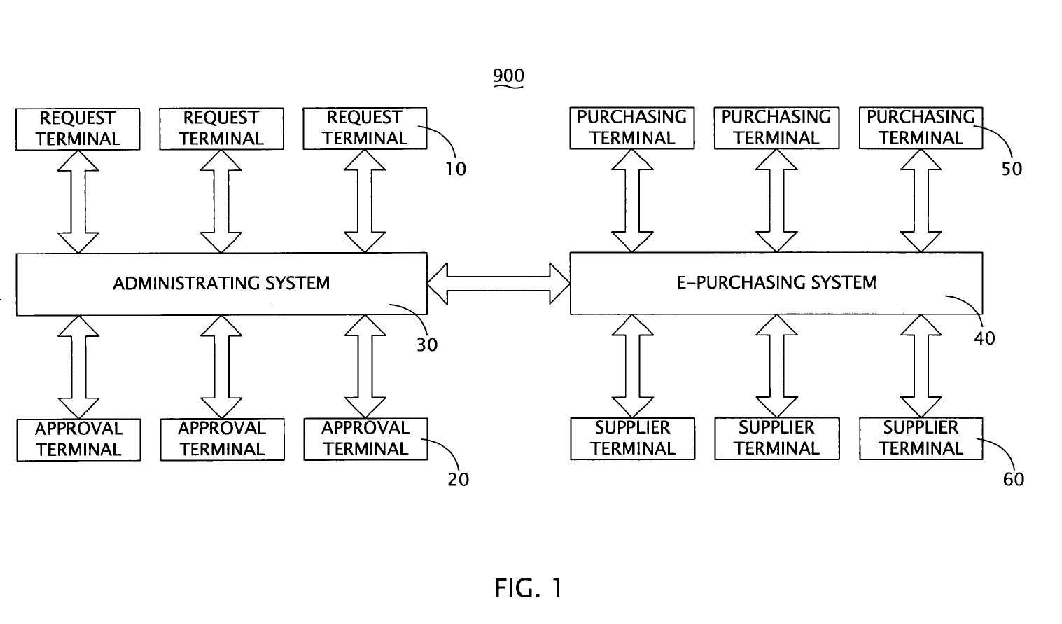

Referring to FIG. 1, a block diagram of a system environment 900 incorporating an exemplary embodiment of an administrating system is illustrated. The system environment 900 includes a plurality of request terminals 10, a plurality of approval terminals 20, and an administrating system 30 that connects with the request terminals 10 and the approval terminals 20. The system environment 900 also includes an E-purchasing system 40 that connects to the administrating system 30, a plurality of purchasing terminals 50, and a plurality of supplier terminals 60.

The request terminals 10 are configured for being accessible by clerks in a company or a factory to gather information. Such information may include product prices, product producers, and product packages of the materials to be purchased and other necessary information of the materials. The clerks may access the request terminals 10 to send a purchasing request message to the administrating system 30 based on the gathered information.

The request terminals 10 are also configured for being accessible by the clerks to configure a priority of the purchasing request message, the priority may be chosen from a list that ranks the priority into several grade. Preferably, the priority may be either of “urgent” and “normal”.

The request terminals 10 are also accessible by the clerks to check a status of the purchasing request message. The clerks may access the request terminals 10 to send a query command to the administrating system 30. After receiving the query command, the administrating system 30 would process the query command and send a query response that contains the current status of the purchasing request message to the request terminal. When the request terminals 10 receive the query response, the request terminals 10 display the current status of the purchasing request message on screens.

The approval terminals 20 are configured for receiving the purchasing request message, and messaging the managers (or other persons in charge) to assess the purchasing request message and further send a request reply message that contains a decision of the purchasing request message to the administrating system 30. The decision of the purchasing request message may be either of an approval decision and a denied decision.

The administrating system 30 is configured for receiving the purchasing request message sent from the request terminals 10, and forwarding the purchasing request message to the approval terminals 20 immediately or at a scheduled time based on the priority of the purchasing request message. For example, if the priority of the purchasing request message is “urgent”, the administrating system 30 would send this purchasing request message to a corresponding approval terminal 20 immediately, or if the priority of the purchasing request message is “normal”, the purchasing request message would be sent with other request messages received at the scheduled time, such as at 4:00 p.m. everyday. Preferably, the administrating system 10 sends the purchasing request messages through E-mails.

The administrating system 30 is also configured for receiving a request reply message sent from the approval terminals 20, and for sending other relative information to the request terminals 10 or the E-purchasing system 40 based on the request reply message. For example, if the decision in the request reply message is an approval decision, the administrating system 30 will send the purchasing request message to the E-purchasing system 40, for messaging the purchasing department to perform the purchasing. Contrary, if the decision in the request reply message is a rejected decision, the administrating system 30 will send a rejection message to the corresponding request terminals 10, for messaging the clerk that the purchasing request message has been rejected, thus the clerk may make an amendment to the purchasing request message and resend the purchasing request message to the administrating system 30 again for approval.

The E-purchasing system 40 is configured for receiving the purchasing request message with the approval decision from the administrating system 30, and instructions sent from the purchasing terminals 50. The E-purchasing system 40 gathers purchasing request messages that purchases a same material and generates a purchasing order according to a batching command sent from the purchasing terminals 50. The E-purchasing system 40 may also be configured for receiving a transmitting command sent from the purchasing terminals 50. When the E-purchasing system 40 receives the transmitting command, the E-purchasing system 40 sends the purchasing order to corresponding supplier terminals 60, thus, messaging the suppliers to deliver purchased materials. Thus, a purchasing procedure is done.

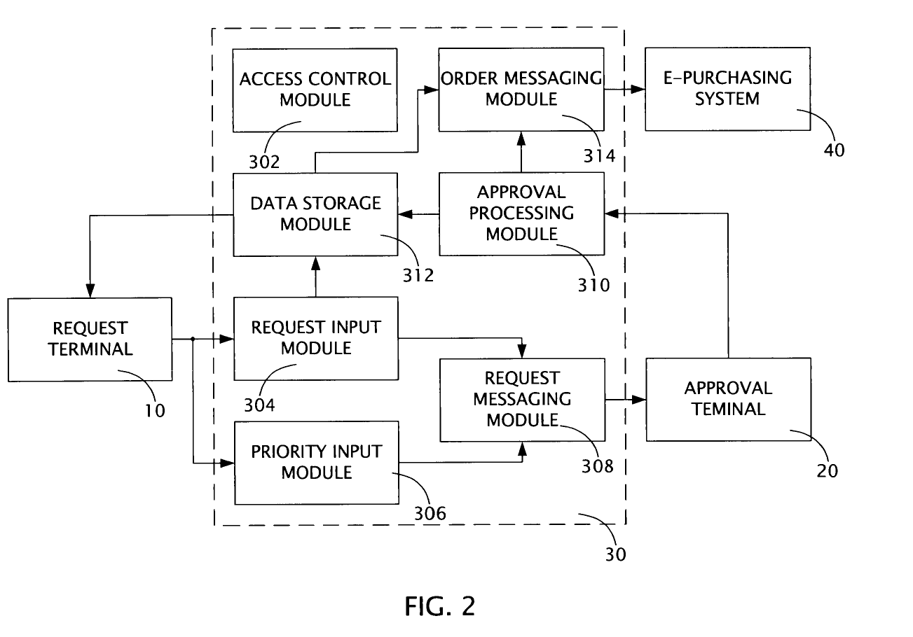

Referring to FIG. 2, a detailed block diagram of the administrating system in accordance with an exemplary embodiment is illustrated. The administrating system 30 includes an access control module 302, a request input module 304, a priority input module 306, a request messaging module 308, an approval processing module 310, a data storage module 312, and an order messaging module 314.

The access control module 302 is used for controlling users access rights of the administrating system 30. For example, the clerks may only have access rights to input a purchasing request message, input the query command for viewing the status of the purchasing request message; and the managers may have access rights to reply the purchasing request message, change an amount of the purchased materials or other necessary information.

The request input module 304 is used for receiving the purchasing request message sent from the request terminals 10. The request input module 304 forwards the purchasing request message to the request messaging module 308 and the data storage module 312.

The priority input module 306 is configured for receiving/reading the priority of the purchasing request message. The priority input module 306 sends the priority of the purchasing request message to the request messaging module 308.

The request messaging module 308 is used for sending the purchasing request messages that have been received from the request input module 304 to the corresponding approval terminals 20 based on the priority of the purchasing request message sent from the priority input module 306.

The approval processing module 310 is used for receiving and processing the request reply message sent from the approval terminals 20, and sending corresponding instructions to the data storage module 312. For example, if the request reply message contains the approval decision, the approval processing module 310 signals the data storage module 312 to generate a purchasing order; or if the request reply message indicates that the purchasing request message is rejected, the approval processing module 310 signals the data storage module 312 to generate a rejection message.

The data storage module 312 is used for storing the purchasing request message and the request reply message, and generating the purchasing order or the rejection message. The data storage module 312 sends the purchasing order to the order messaging module 314, or sends the rejection message to the request terminals 10.

The order messaging module 314 is used for sending the purchasing order to the E-purchasing system 40, for messaging the purchasing department to perform the purchasing.

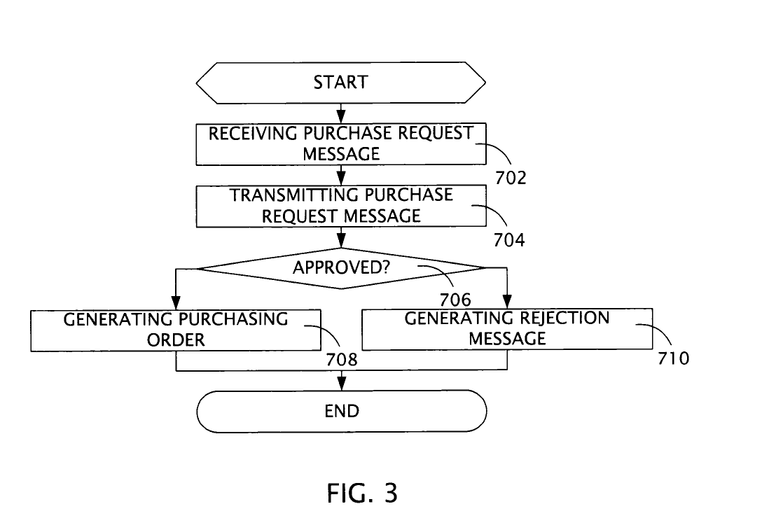

Referring now to FIG. 3, a flow chart of an administrating method in accordance with an exemplary embodiment is illustrated. First, in step 702, the administrating system 30 receives the purchasing request message.

Second, in step 704, the administrating system 30 transmits the purchasing request message to the approval terminals 20 for approval.

Third, in step 706, the administrating system 30 determines whether the decision of purchasing request message in the request reply message is approved or rejected.

In step 708, if the decision in the request reply message is the approval decision, a purchasing order is generated.

In step 710, if the decision in the request reply message is the rejected decision, the rejection message is sent to the request terminals 10 for messaging the rejection to the clerk.

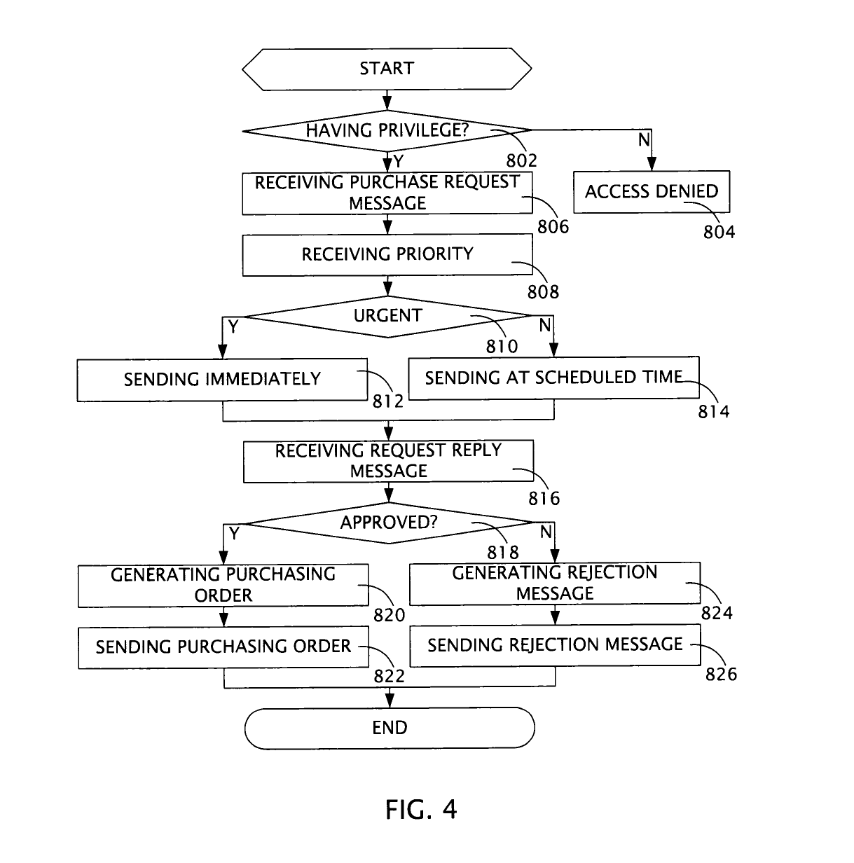

Referring to FIG. 4, a more detailed flow chart illustrating an exemplary embodiment of the administrating method for material purchasing is shown. To be more definite, the administrating method will be described below incorporating the administrating system 30 as described in FIG. 2.

Step 802, the access control module 302 detects whether a user has the privileges to access the administrating system 30.

Step 804, if the user does not have the privileges, access to the administrating system 30 will be denied.

Step 806, if the user has the privileges, the request input module 304 receives the purchasing request message from the request terminals 10. The purchasing request message is forwarded to the request messaging module 308, so as to be sent to the approval terminals 20 and to the data storage module 312 for being stored.

Step 808, the priority input module 306 receives a priority of the purchasing request message. Preferably, as a default value, “normal” is set to the purchasing request message when the request terminals 10 don't send any priority setting. The priority of the purchasing request message is also sent to the request messaging module 308.

Step 810, the request messaging module 308 detects the priority of the purchasing request message, for computing when to send the purchasing request message to the approval terminals 20.

Step 812, the request messaging module 308 sends the purchasing request message to the approval terminals 20 immediately if the priority of the purchasing request message is “urgent”.

Step 814, the request messaging module 308 sends the purchasing request message to the approval terminals 20 at the scheduled time if the priority of the purchasing request message is “normal”.

Step 816, the approval processing module 310 receives the request reply message sent from the approval terminals 20.

Step 818, the approval processing module 310 reads the decision of the request reply message contained in the request reply message.

Step 820, the data storage module 312 generates a purchasing order when the decision indicates that the purchasing request message is approved. The generated purchasing order is transmitted to the order messaging module 314.

Step 822, the order messaging module 314 sends the purchasing order to the E-purchasing system 40.

Step 824, the data storage module 312 generates a rejection message if the decision indicating that the purchasing request message is rejected.

Step 826, the data storage module 312 sends the rejection message to the request terminals 10.

Based on the administrating system 30 and the administrating method, clerks in a company or a workshop don't have to spend a lot of time preparing request documents, rush all the way to deliver the request documents to be approved, waiting while the request documents being checked, and so on. The managers don't need to worry about being disturbed all the time to sign for approval. Thus, both the clerks and the managers will enjoy a highly effective working flow.

What is claimed is:

1. An administrating system for material purchasing, comprising:
a request input module for receiving a purchasing request message from a request terminal;
a request messaging module for forwarding the purchasing request message to an approval terminal;
an approval processing module for receiving a request reply message to the purchasing request message from the approval terminal.

2. The administrating system as claimed in claim 1, further comprising a priority input module for receiving a priority of the purchasing request message, wherein the priority of the purchasing request message determines the time when the request messaging module sends the purchasing request message to the approval terminal.

3. The administrating system as claimed in claim 2, wherein said priority of the purchasing request message is chosen from a group consisting of “urgent” and “normal”.

4. The administrating system as claimed in claim 1, wherein said request reply message to the purchasing request message indicates that the purchasing request message is approved or rejected.

5. The administrating system as claimed in claim 4, further comprising a data storage module for storing the purchasing request message and the request reply message.

6. The administrating system as claimed in claim 5, wherein said data storage module is for generating a purchasing order at an occurrence that the request reply message indicates that the purchasing request message is approved.

7. The administrating system as claimed in claim 6, further comprising an order messaging module for receiving the purchasing order, and sending the purchasing order to an E-purchasing system.

8. The administrating system as claimed in claim 6, wherein said data storage module is for generating a rejection message and sends the rejection message to the corresponding request terminal at the occurrence that the response indicates that the purchasing request message is rejected.

9. An administrating method for material purchasing, comprising the steps of:
receiving a purchasing request message;
forwarding the purchasing request message to be approved; and
generating a purchasing order.

10. The administrating method as claimed in claim 9, further comprising the following steps of:
receiving a priority of the purchasing request message; and
determining the priority of the purchasing request message.

11. The administrating method as claimed in claim 10, further comprising the steps of:
forwarding the purchasing request message immediately at an occurrence that the priority indicates that the purchasing request message is urgent; and
forwarding the purchasing request message at a scheduled time at an occurrence that the priority indicates that the purchasing request message is in normal priority.

12. The administrating method as claimed in claim 9, further comprising the steps of:
receiving a request reply message for the purchasing request message;
determining a decision in the request reply message to be an approval decision or a rejected decision;
generating a purchasing order at an occurrence that the request decision indicates that the purchasing request message is approved; and
generating a rejection message at the occurrence that the request decision indicates that the purchasing request message is rejected.

13. The administrating method as claimed in claim 12, further comprising the steps of:
sending the purchasing order; and
sending the rejection message.
